(19) United States
(12) Patent Application Publication
(10) Pub. No.: US 2026/0241546 A1
(43) Pub. Date: Aug. 20, 2026

(54) TEACHING SYSTEM AND CORRESPONDING METHOD

(71) Applicant: ABB SCHWEIZ AG, Baden (CH)

(72) Inventors: Qizhen Lv, Shanghai (CN); Ye Tian, Shanghai (CN); Xinyu Fang, Shanghai (CN)

(21) Appl. No.: 19/656,718

(22) Filed: Apr. 23, 2026

Related U.S. Application Data
(63) Continuation of application No. PCT/CN2023/126611, filed on Oct. 25, 2023.

(51) Int. Cl. B25J 9/00; B25J 11/00

(52) U.S. Cl. CPC B25J 9/0081; B25J 11/0075

(57) ABSTRACT

The present disclosure relates to a teaching system and a corresponding method. The teaching system includes a robot having a robot flange coupled to a first workpiece; and a teaching device having a teaching flange coupled to a second workpiece, the teaching device is configured to move in a route with a set of parameters. The second workpiece is the same with the first workpiece and the teaching flange is the same with the robot flange such that the robot can move by following the same route of the teaching device with the same set of parameters.

### FIELD

Example embodiments of the present disclosure generally relate to the industrial field, and more particularly, to a teaching system and a corresponding method for use with the teaching system.

### BACKGROUND

In the manufacturing industries, spray painting robots can be used for spray painting car bodies to improve painting efficiency and quality. In the home appliance manufacturing industry, spray painting robots can be used for spray painting home appliances such as air conditioners, refrigerators, and washing machines to improve painting efficiency and quality. Additionally, spray painting robots can also be applied in fields such as furniture manufacturing, electronic product manufacturing, and construction industries.

Robotic painting teaching is a time-consuming and costly process. Traditional programming of painting robots requires an experienced robotic engineer to spend a day manually generating the route. Additionally, as the engineer cannot see the painting results during the route generation period, it often takes a couple of days to adjust the route and process parameters to achieve perfect painting results. Also, this time-consuming teaching process makes it difficult for small companies whose orders usually only consist of a few hundred products to use painting robots.

### SUMMARY

In general, example embodiments of the present disclosure provide a teaching system and a corresponding method, which address the existing problems and/or any potential problems.

In a first aspect, there is provided a teaching system used for robot. The teaching system comprises: a robot having a robot flange coupled to a first workpiece; and a teaching device having a teaching flange coupled to a second workpiece, the teaching device is configured to move in a route with a set of parameters; wherein the second workpiece is the same with the first workpiece and teaching flange is the same with the robot flange such that the robot can move by following the same route of the teaching device with the same set of parameters.

According to the example embodiments of the present disclosure, there is no need to additionally calibrate the teaching device to the robot and the robot can move by following the same route of the teaching device with the same set of parameters

In some example embodiments, the teaching device further comprises: a sensor configured to record the route along with the teaching device moves.

In some example embodiments, the teaching device further comprises: an adjusting module configured to adjust the set of parameters.

In some example embodiments, the set of parameters comprises painting pressure, painting color, painting rate, painting speed, brush shape and the combination thereof.

In some example embodiments, the teaching device further comprises an input module configured to receive an input instruction from the user.

In some example embodiments, the teaching system further comprises a painting controller coupled between the robot and the teaching device and configured to share data flow and/or painting flow between the robot and the teaching device.

In a second aspect, there is provided a method for use with a teaching system. The teaching system comprises a robot having a robot flange coupled to a first workpiece and a teaching device having a teaching flange coupled to a second workpiece, wherein the second workpiece is the same with the first workpiece and teaching flange is the same with the robot flange. The method comprises: actuating the teaching device to move in a route with a set of parameters; and actuating the robot to move by following the same route of the teaching device with the same set of parameters.

### BRIEF DESCRIPTION OF THE DRAWINGS

Through the following detailed description with reference to the accompanying drawings, the above and other objectives, features and advantages of the example embodiments disclosed herein will become more comprehensible. In the drawings, several example embodiments disclosed herein will be illustrated in an exemplary and in a non-limiting manner, wherein:

FIG. 1 illustrates a schematic view of the teaching system in accordance with an example embodiment of the present disclosure;

FIG. 2 illustrates schematic view of the teaching device in accordance with an example embodiment of the present disclosure;

FIGS. 3A-3B illustrate the coupling between the robot and the robot paining gun and the coupling between the teaching device 20 and the teaching paining gun, respectively; and

FIG. 4 illustrates a flowchart of a method for use with a teaching system in accordance with an example embodiment of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and to help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skill in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to apply such feature, structure, or characteristic in connection with other embodiments whether or not explicitly described.

It should be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

A variety of approaches have been proposed to teach robot to paint. However, as described above, these conventional approaches still have many disadvantages.

For example, a magnetic field may be utilized to record the painting route. Yet, this method requires a lot of time to set up. Worse still, if the workpiece to be painted is metal, accuracy of this method will deteriorate rapidly. Also, the operator cannot see the painting result during the teaching process.

As another example, a specialized robot that can be grabbed by an operator. The specialized robot requires a special mechanical design, which includes extra springs, dampers, and encoders to record the painting route. These extra mechanical structures make those robots more expensive. It is also hard for the operate to see the painting result and there are safety hazards during operation.

As a further example, a tracking programming by using VR (Virtual Reality) may also be applied. Yet, the VR tracking is not really accurate, with the accuracy being around 1 centimeter. Moreover, VR cannot simulate the painting process well enough.

At least to address the problem existed in the conventional approaches, the present disclosure proposes a solution involving a teaching system including a robot and a teaching device coupled to the robot. The teaching device is configured to teach the robot how to move. For example, if the robot is used for painting, the teaching device can teach the robot to move along what kinds of route and teach the robot to paint at how much painting flow rate. The teaching device can be held by an operator, who can use it to paint the workpiece as a teaching example. The operator can see the result during painting intuitively. The teaching device will record the route using sensors and also record the painting parameter, for example painting pressure, the painting color, the painting rate, painting speed, brush shape, during painting. The teaching device will turn the data it recorded from the painting process into robot code and thus the robot can paint the workpiece the same as the operator did.

According to example embodiments of the present disclosure, the teaching device can share the same material and information flow with the robot, which will be described in more detail hereinafter.

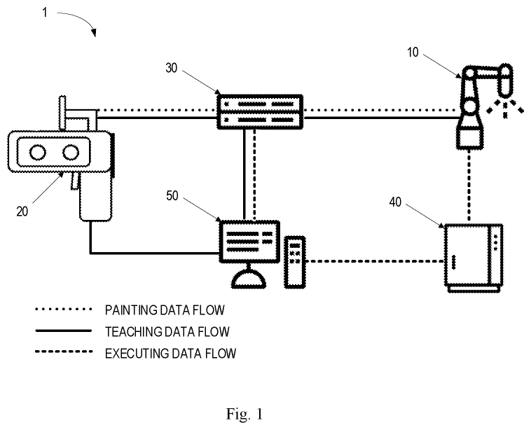

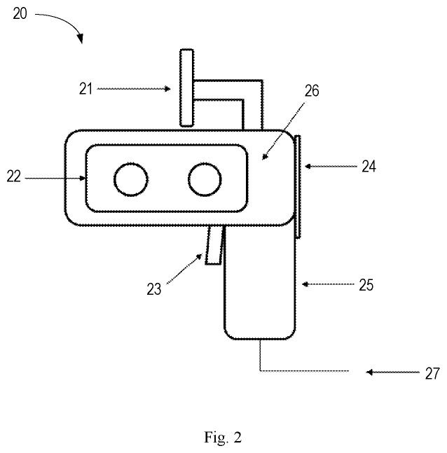

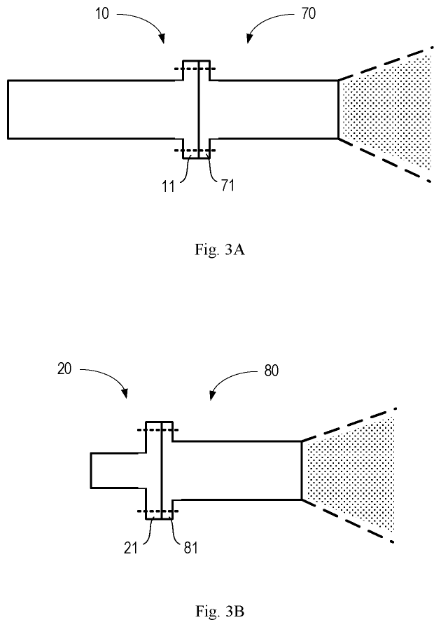

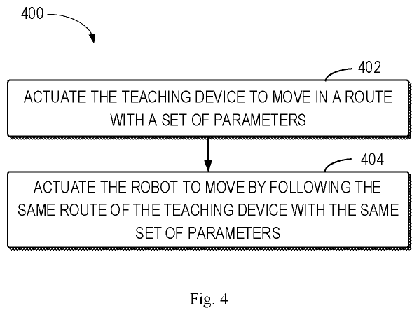

Example embodiments of the present disclosure will be described in more detail hereinafter in accordance with FIGS. 1-4, wherein FIG. 1 illustrates a schematic view of the teaching system in accordance with an example embodiment of the present disclosure; FIG. 2 illustrates schematic view of the teaching device in accordance with an example embodiment of the present disclosure; FIGS. 3A-3B illustrate the coupling between the robot and the robot paining gun and the coupling between the teaching device 20 and the teaching paining gun, respectively; and FIG. 4 illustrates a flowchart of a method for use with a teaching system in accordance with an example embodiment of the present disclosure.

As can be seen from FIG. 1, the teaching system 1 includes a robot 10 and a teaching device 20. The robot 10 may be any kinds of industrial robot and the specific type of the robot 10 are not limited to embodiments of the present disclosure. As shown in FIG. 3, the robot 10 has a robot flange 11 coupled to a first workpiece 70 and the teaching device 20 has a teaching flange 21 coupled to a second workpiece 80.

The example embodiment described herein will use painting as a scenario for description wherein the first workpiece 70 and the second workpiece 80 are painting guns which may spray a variety of material onto the object to be painted. It is to be understood that this is only for illustration without suggesting any limitations as to the scope of the subject matter described here the above embodiments may be used in other scenarios.

As can be seen from FIG. 3A, the robot flange 11 of the robot 10 is coupled to a gun flange 71 of the robot painting gun as an example of the first workpiece 70 to establish the coupling between the robot 10 and the robot paining gun. As can be seen from FIG. 3B, the teaching flange 21 of the teaching device 20 is coupled to a gun flange 81 of the teaching painting gun as an example of the second workpiece 80 to establish the coupling between the teaching device 20 and the teaching paining gun.

The teaching device 20 may be grasped by the operator to move in a route with a set of parameters;

According to the example embodiments of the present disclosure, the second workpiece 80 is the same with the first workpiece and teaching flange 21 is the same with the robot flange 11. Owing to the fact that the teaching painting gun coupled to the teaching device 20 is the same with the robot paining gun coupled to the robot 10 and the teaching flange 21 is the same with the robot flange 11, there is no need to additionally calibrate the teaching device 20 to the robot 10. In this manner, the robot 10 will execute the same action as the operator and the painting result will be the same. In this way, the robot 10 can move by following the same route of the teaching device 20 with the same set of parameters.

As can be seen from FIG. 1, the painting data flow and/or painting flow can be transmitted between the teaching device 20 and the painting controller 30 as well as between the painting controller 30 and the robot 10. The teaching data flow and/or painting flow can be transmitted among the teaching device 20, the painting controller 30 and the industrial personal computer 50. The teaching data can also be transmitted between the painting controller 30 and the robot 10. The executing data flow can be transmitted between the painting controller 30 and the industrial personal computer 50, the industrial personal computer 50 and the robot controller 40, the robot controller 40 and the robot 10. A variety of data can be shared among the different components within the teaching system 1. In this way, the parameters used by the teaching device 20 in the teaching process can be used in the painting process by the robot 10 without extra calibration work.

As shown in FIG. 1, the teaching device 20 may be connected to an industrial personal computer 50. All the algorithms including Visual Simultaneous Localization and Mapping (VSLAM), inverse kinematic, etc. will run on the industrial personal computer 50.

As shown in FIG. 1, the teaching system 1 further includes a painting controller 30 coupled between the robot 10 and the teaching device 20. The painting controller 30 is configured to transmit data flow and/or painting flow between the robot 10 and the teaching device 20.

As shown in FIG. 1, the teaching system 1 further includes a robot controller 40 coupled to the robot 10. The robot controller 40 is configured to control the operation of the robot 10.

As shown in FIG. 2, teaching device 20 may further include a sensor 22. The sensor 22 is configured to record the route along with the teaching device 20 moves. The sensor 22 may be a VSLAM sensor configured to record the route with VSLAM algorithm and the recorded data may be transmitted to the industrial personal computer 50 for further processing. In some example embodiment, the sensor 22 may be a camera.

In some example embodiments, the teaching device 20 may further include an adjusting module 23, which is configured to adjust the set of parameters. As shown in FIG. 2, the adjusting module 23 may take a form of a trigger. For example, the trigger may be used to turn on or turn off the teaching device 20 and also to control the flow rate or volume of the paint. In other example embodiments, the adjusting module 23 may be configured as other possible forms. For example, the adjusting module 23 may be a switch, a button or a joystick. It is to be understood that the adjusting module 23 may be of any other suitable input device, depending on the actual scenario or individual requirement from the user. As shown in FIG. 2, there is a signal cable 27 connected to the painting system/robot controller to control the painting process.

In the shown embodiment, the teaching device 20 further comprises an input module 24 configured to receive an input instruction from the user. The input module 24 may include a screen and several buttons on the device for the user to adjust the painting parameters. The teaching device 20 will record all painting parameters during the teaching process.

In the shown embodiment, the teaching device 20 may include a microcontroller unit 26 for calculation.

During the teaching process, the teaching device 20 will calculate whether the current pose is within the robot's reach and whether the current pose is near the robot's singularity. In some example embodiments, there is a screen, a speaker, and led lights on the device to warn the user if the current pose is near the limitation of the robot's reach or if it is near the singularity. The user can then adjust the painting route.

After the teaching process, the teaching device 20 will turn the data it recorded, including the route and the painting parameter, into robot code and automatically load it into the robot 10. As shown in FIG. 1, the teaching device 20 may share the same information and painting flow with the robot 10. By using the example embodiment described herein, the robot 10 coding will require much less time and the operator does not need to know how to do robot programming. Moreover, the operator can see the painting result during the teaching process which reduces or even does not require any adjustment after the route is generated.

The example embodiment according to the present disclosure may be implemented in a painting scenario as below.

First, the same painting gun may be mounted both on the teaching flange 21 of the teaching device 20 and the robot flange 11 of the robot 10. The teaching flange 21 of the teaching device 20 is the same as the one on the robot 10. In this way, there is no need for extra calibration work to mount the painting gun for the operator.

Second, the operator connects the robot 10, the teaching device 20, the robot controller 40, the painting controller 30, and the industrial personal computer 50 together.

Third, the operator presets the set of painting parameters including the painting pressure, the painting color, the painting rate, painting speed, brush shape, etc.

The operator handles the teaching device 20 by grasping the handle 25 to conduct the teaching process. The teaching device will record the route and the painting parameters during the teaching process and send it to the industrial personal computer 50. The teaching route will be recorded in any known method or any method to be developed in the future. The teaching route may be then encoded into code. The industrial personal computer 50 will calculate whether the current pose is beyond the robot's reach or near the singularity. The teaching device 20 may warn the operator if the current pose is unreachable.

After the teaching process has been completed, the operator may start the painting process for example by pressing a related button. The robot controller 40 of the robot 10 may understand that the teaching process has been completed and the painting process begins. The code encoded during the teaching process may be transferred to the robot 10 and then be decoded. In this way, the robot 10 coupled with a robot painting gun may follow the painting route according to the code. Since the code is encoded during the teaching process, the painting route along which the robot 10 moves is identical with the teaching route along which the teaching device 20 moves.

In some example embodiment, if necessary, the operator may adjust the route after teaching.

As shown in FIG. 4, there is provided a method 400 for use with a teaching system 1 in a second aspect. At block 402, the teaching device 20 is actuated to move in a route with a set of parameters. At block 404, the robot 10 is actuated to move by following the same route of the teaching device 20 with the same set of parameters.

Compared with the conventional approaches, the example embodiments according to the present disclosure does not require the painting operator to have special knowledge about robot programming to use the robot to paint. Specifically, since the same paint gun and same flanges are used to paint the workpiece, no extra calibration task is needed. During the teaching process, the operator can see the painting result intuitively. Since the teaching data (for example, a set of parameters including painting pressure, painting color, painting rate, painting speed, brush shape and the combination thereof) of the teaching device 20 are shared by the robot 10 which conducts the real painting work for the object, the robot 10 can completely follow the same route with the same parameters as the teaching device 20. In this manner, the effect of what you see is what you get can be achieved. Moreover, the painting device 20 will reduce both the time and cost of painting robot programming, which makes it possible for small factories to use robots in the painting process.

It is to be understood that although the above disclosure is described by taking the workpiece painting scenario as examples, this is only for illustration without suggesting any limitations as to the scope of the subject matter described here the above embodiments may be used in other scenarios.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A teaching system used for a robot, comprising:
a robot having a robot flange coupled to a first workpiece; and
a teaching device having a teaching flange coupled to a second workpiece, the teaching device is configured to move in a route with a set of parameters;
wherein the second workpiece is the same with the first workpiece and the teaching flange is the same with the robot flange such that the robot can move by following the same route of the teaching device with the same set of parameters.

2. The teaching system of claim 1, wherein the teaching device further comprises:
a sensor configured to record the route along with the teaching device moves.

3. The teaching system of claim 1, wherein the teaching device further comprises:
an adjusting module configured to adjust the set of parameters.

4. The teaching system of claim 1, wherein the set of parameters comprises painting pressure, painting color, painting rate, painting speed, brush shape and the combination thereof.

5. The teaching system of claim 1, wherein the teaching device further comprises an input module configured to receive an input instruction from the user.

6. The teaching system of claim 1, further comprising a painting controller coupled between the robot and the teaching device and configured to share data flow and/or painting flow between the robot and the teaching device.

7. A method for use with a teaching system, the teaching system comprising a robot having a robot flange coupled to a first workpiece and a teaching device having a teaching flange coupled to a second workpiece, wherein the second workpiece is the same with the first workpiece and teaching flange is the same with the robot flange the method comprising:
actuating the teaching device to move in a route with a set of parameters; and
actuating the robot to move by following the same route of the teaching device with the same set of parameters.
